(19) United States
(12) Patent Application Publication
(10) Pub. No.: US 2021/0124146 A1
(43) Pub. Date: Apr. 29, 2021

(54) LOW WAVEFRONT DISTORTION OPTICAL MOUNT FOR THIN OPTICAL COMPONENTS

(71) Applicant: Newport Corporation, Irvine, CA (US)

(72) Inventors: Wen Xu Jin, Laguna Hills, CA (US); Warren Booth, Laguna Hills, CA (US)

(73) Assignee: Newport Corporation, Irvine, CA (US)

(21) Appl. No.: 17/070,039

(22) Filed: Oct. 14, 2020

Related U.S. Application Data
(60) Provisional application No. 62/926,701, filed on Oct. 28, 2019.

(51) Int. Cl. G02B 7/182

(52) U.S. Cl. CPC G02B 7/182

(57) ABSTRACT

The present application discloses embodiments of a mount for optical components configured to secure thin optical components while minimizing wavefront distortion effects. The optical mount may include at least one mount body with at least one optical component receiving recess formed therein, the at least one optical component receiving recess configured to receive at least one optical component therein, the optical component having at least one edge. The mount may include one or more elastomeric retention members configured to exert at least one compliant retention force to the edge of the optical component, thereby securely retaining the optical component within the optical component receiving recess.

### CROSS-REFERENCE TO RELATED APPLICATIONS

The present application claims priority to U.S. Provisional Patent Application Ser. No. 62/926,701—entitled “Low Wavefront Distortion Optical Mount for Thin Optical Components”, filed on Oct. 28, 2019, the contents of which are incorporated by reference herein.

### BACKGROUND

Optical component mounts used in a wide variety of applications. Presently, they are used to hold various optical components such as lenses and mirrors that are used in optical and laser experiments, as components in laser systems, and in biomedical instrumentation. Some applications are very sensitive to wavefront distortions caused by stresses or distortions in the optical components induced by the retention devices used to hold the optical components in place in the optical component mount. While some optical component mount designs have reduced wavefront distortion, some shortcomings have been identified. For example, thin optical components are especially susceptible to stress and distortion, and retention devices may cause an unacceptable amount of stress in and distortion of the optical component, affecting the results of sensitive laser experiments or affecting the performance of laser systems or instruments that use such optical component mounts.

Thus, there is an ongoing need for an optical component mount that reduces or eliminates the wavefront distortion of thin optical components.

### SUMMARY

The present application is directed to a novel mount for an optical component. In one embodiment, the optical component mount may include at least one mount body with at least one optical component receiving recess formed therein, the at least one optical component receiving recess configured to receive at least one optical component therein, the at least one optical component having at least one edge. The optical component mount may further include at least one elastomeric retention member configured to exert at least one compliant retention force to at least one edge of the optical component and securely retain the optical component within the optical component receiving recess in at least one first direction. In one embodiment, the elastomeric retention member has an annular shape with substantially circular cross-section. In another embodiment, the elastomeric retention member may have an annular shape with a rectangular cross-section. In another embodiment, the elastomeric retention member may have a solid oval cross-section. In another embodiment, the elastomeric retention member may have a rectangular cross-section. The elastomeric retention member may be formed from a material selected from a group consisting of butyl, nitrile (Buna-N), silicone, fluorocarbon, fluorosilicone, fluoroelastomer, urethane, polyurethane, perfluoroelastomer (FFKM), polytetrafluoroethylene (PTFE), tetrafluoroethylene propylene (TFE/P), ethylene-propylene (EPDM), neoprene, and chloroprene.

In another embodiment, the optical component mount may further include at least one adjustment member configured to exert at least one adjustable biasing force to the elastomeric retention member, thereby adjusting the compliant retention force applied to the edge of the optical component by the elastomeric retention member.

In another embodiment, the optical component mount may include at least one mount body with at least one optical component receiving recess formed therein, the at least one optical component receiving recess configured to receive at least one optical component therein, the at least one optical component having at least one edge. The optical component mount may further include at least one first elastomeric retention member configured to exert at least one compliant retention force to at least one edge of the optical component in at least one first direction, and at least one second elastomeric retention member configured to exert at least one compliant retention force to the edge of the optical component in at least one second direction, thereby securely retaining the optical component within the optical component receiving recess in at least one first direction and at least one second direction.

In another embodiment, the optical component mount may further include at least one third elastomeric retention member configured to exert at least one compliant retention force to the edge of the optical component at at least one contact area and securely retain the optical component in at least one third direction.

### BRIEF DESCRIPTION OF THE DRAWINGS

Various embodiments of a low-wavefront-distortion optical mount for thin optical components will be explained in more detail by the accompanying drawings, wherein:

FIG. 1 shows an exploded perspective view of a prior art optical component mount;

FIG. 2 shows a cross-sectional view of the prior art optical component mount shown in FIG. 1;

FIG. 3 shows an exploded perspective view of an embodiment of a low-wavefront-distortion optical component mount for thin optical components;

FIG. 4 shows a perspective view of the embodiment of the mount body of the optical component mount shown in FIG. 3;

FIG. 5 shows a front view of the embodiment of the mount body of the optical component mount shown in FIGS. 3 and 4;

FIG. 6 shows a front view of the embodiment of the optical mount shown in FIG. 3;

FIG. 7 shows a cross-sectional view of the embodiment of the optical component mount shown in FIGS. 3-6;

FIG. 8 shows a front view of the embodiment of the optical component mount shown in FIGS. 6 and 7;

FIGS. 9A and 9B show detailed views of the retention member and the optical component of the embodiment of the optical component mount shown in FIGS. 3-8;

FIG. 10 shows a cross-sectional view of an alternate embodiment of a low-wavefront-distortion optical component mount for thin optical components;

FIG. 11 shows a cross-sectional view of an alternate embodiment of a low-wavefront-distortion optical component mount for thin optical components;

FIG. 12 shows a cross-sectional view of an alternate embodiment of a low-wavefront-distortion optical component mount for thin optical components;

FIG. 13 shows a cross-sectional view of an alternate embodiment of a low-wavefront-distortion optical component mount for thin optical components;

FIG. 14 shows a front view of an alternate embodiment of a low-wavefront-distortion optical component mount for thin optical components; and

FIG. 15 shows a front view of the embodiment of the optical component mount shown in FIG. 14.

### DETAILED DESCRIPTION

The present application is directed to an optical component mount and related devices that are configured to provide retention of thin optical components with reduced stresses on the optical component. The various embodiments described herein are directed to optical component mounts and similar devices, those skilled in the art will appreciate that the components and retention devices described herein may be used in any variety of applications to prevent undesirable stresses of the optical component.

Example embodiments are described herein with reference to the accompanying drawings. Unless otherwise expressly stated, in the drawings the sizes, positions, etc., of components, features, elements, etc., as well as any distances therebetween, are not necessarily to scale, but are exaggerated for clarity. In the drawings, like numbers refer to like elements throughout. Thus, the same or similar numbers may be described with reference to other drawings even if they are neither mentioned nor described in the corresponding drawing. Also, even elements that are not denoted by reference numbers may be described with reference to other drawings.

The terminology used herein is for the purpose of describing particular exemplary embodiments only and is not intended to be limiting. Unless otherwise defined, all terms (including technical and scientific terms) used herein have the same meaning as commonly understood by one of ordinary skill in the art. As used herein, the singular forms “a,” “an” and “the” are intended to include the plural forms as well, unless the context clearly indicates otherwise. It should be recognized that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless indicated otherwise, terms such as “first,” “second,” etc., are only used to distinguish one element from another. For example, one coupler could be termed a “first coupler” and similarly, another node could be termed a “second coupler”, or vice versa.

Unless indicated otherwise, spatially relative terms, such as “below,” “beneath,” “lower,” “above,” and “upper,” “opposing,” and the like, may be used herein for ease of description to describe one element or feature's relationship to another element or feature, as illustrated in the FIGS. It should be recognized that the spatially relative terms are intended to encompass different orientations in addition to the orientation depicted in the FIGS. For example, if an object in the FIGS. is turned over, elements described as “below” or “beneath” other elements or features would then be oriented “above” the other elements or features. Thus, the exemplary term “below” can encompass both an orientation of above and below. An object may be otherwise oriented (e.g., rotated 90 degrees or at other orientations) and the spatially relative descriptors used herein may be interpreted accordingly.

An XYZ reference coordinate system graphic is shown in the bottom left corner of some of the FIGS., laying out the basic orientation of various axes, directions, and degrees of freedom used in the present disclosure. This graphic is intended only to orient the reader of the patent for ease of understanding and to provide clarity and contrast between the location and relative movement of the various elements, components and systems described herein. This graphic is not intended to mean that any of the axes, directions of motion, degrees of freedom, or angular orientations of any of the disclosed components overlap each other or are orthogonal to each other.

The paragraph numbers used herein are for organizational purposes only and, unless explicitly stated otherwise, are not to be construed as limiting the subject matter described. It will be appreciated that many different forms, embodiments and combinations are possible without deviating from the spirit and teachings of this disclosure and so this disclosure should not be construed as limited to the example embodiments set forth herein. Rather, these examples and embodiments are provided so that this disclosure will be thorough and complete, and will convey the scope of the disclosure to those skilled in the art.

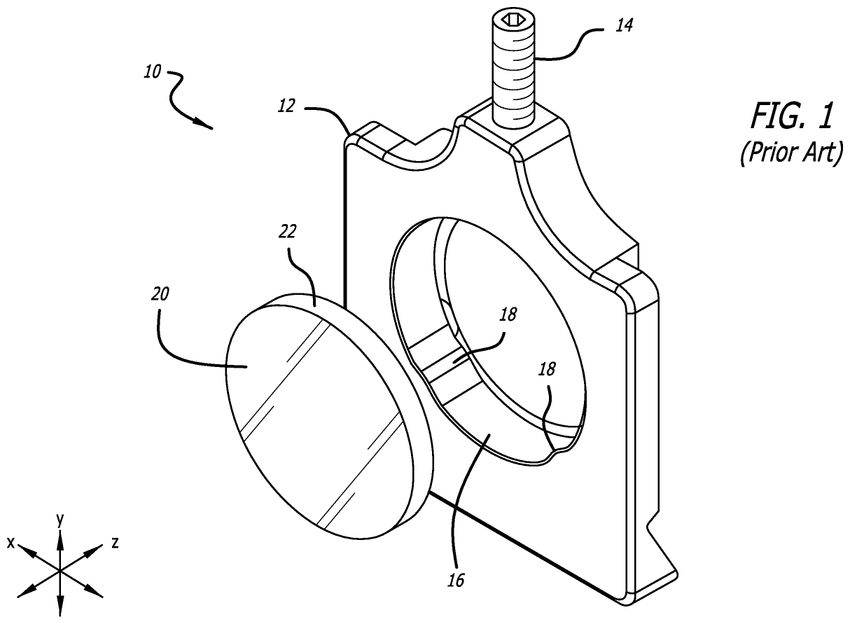

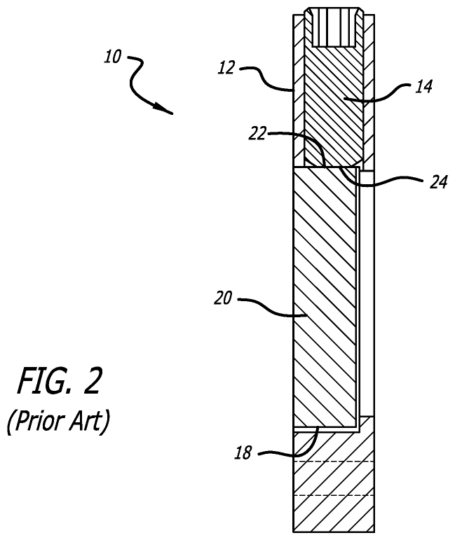

FIGS. 1 and 2 show views of a prior art optical component mount 10. As shown, the optical component mount 10 includes a mount body 12 with a recess 16. The optical component 20 may be retained in the recess 16 by a set screw 14 that applies a biasing force to an edge 22 of the optical component 20 to urge the edge 22 against two support surfaces 18. Generally, the mount body 12 and the set screw 14 are made of metal. As such, when the set screw 14 contacts the edge 22 at a contact region 24, localized compressive stresses and stress-induced birefringence (a change in the refractive index of an optical material due to stress gradients) may be created within the optical component 20, resulting in optical wavefront distortions in the surfaces and body of the optical component 20. In addition, the force exerted by the set screw 14 may warp the optical component 20, also causing optical wavefront distortions in the surfaces of the optical component 20. If changes in ambient temperature cause thermal expansion or contraction of the mount body 12, the set screw 14 and the optical component 20, the stresses in the optical component 20 may change, causing changes in the optical performance of the optical component 20.

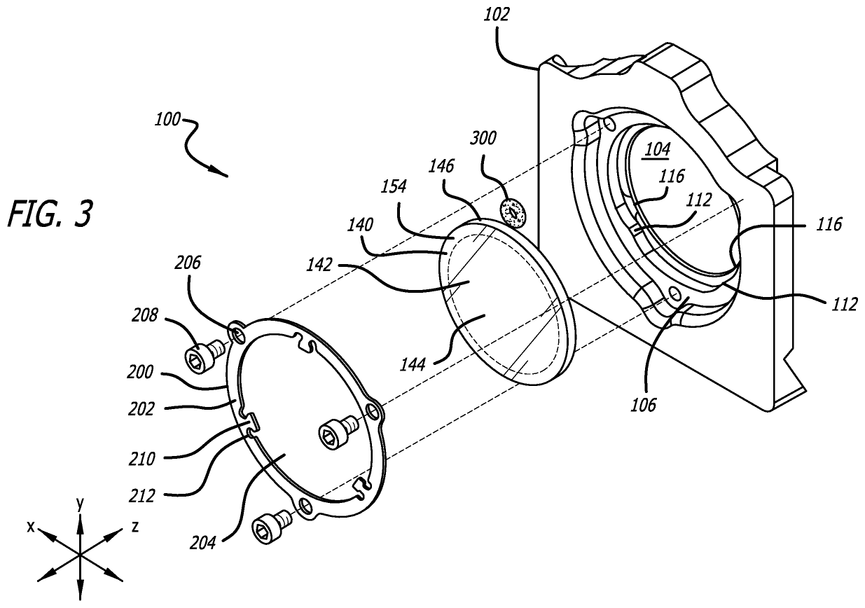

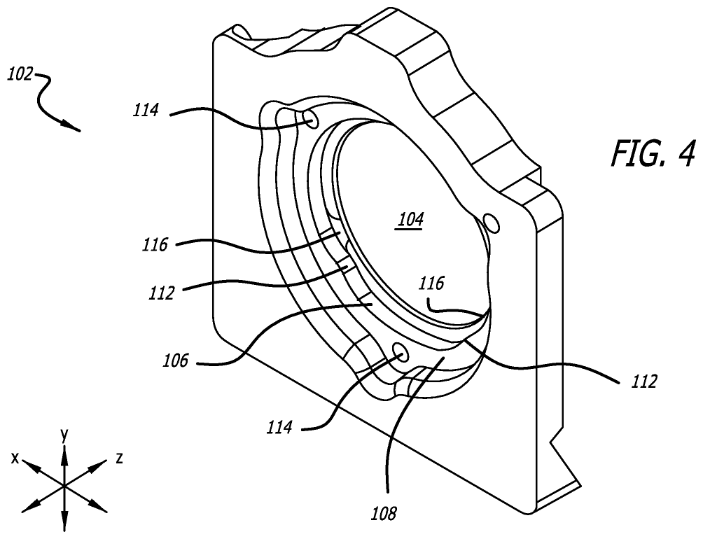

FIG. 3 shows an exploded perspective view of an exemplary embodiment of an improved optical component mount 100 configured to reduce stresses in thin optical components. As shown, the optical component mount 100 (also referred to herein as the “optical mount 100”) may include at least one mount body 102. Exemplary materials for the mount body 102 include, without limitation, aluminum, stainless steel, plastics, alloys, or composite materials. The mount body 102 may also be formed from a variety of materials having low coefficients of thermal expansion, such as Kovar, Invar, Zerodur, or the like or any combination thereof. Those skilled in the art will appreciate that the mount body 102 may be formed of any variety of materials. As shown, the mount body 102 may include at least one optical component receiving recess 106 and at least one aperture 104 formed therein, the optical component receiving recess 106 configured to receive at least one optical component 140 therein. Optionally, the mount body 102 may not have an aperture. In the illustrated embodiment, the optical component receiving recess 106 may be configured to accept a single optical component, though those skilled in the art will appreciate that the optical component receiving recess 106 may be configured to hold any number of optical components 140. Further, as shown in FIGS. 3-5, one or more support surfaces 112 configured to support the optical component 140 thereon may be formed on the mount body 102. In the illustrated embodiment, the mount body 102 includes two support surfaces 112 sufficient to support the optical component 140 in the X- and Y-axes. In the illustrated embodiment, the support surfaces 112 are two rounded raised protrusions extending radially inward into the optical component receiving recess 106. Those skilled in the art will appreciate that the mount body 102 may have any number of support surfaces 112 formed thereon. In another embodiment, the support surfaces 112 may be made of materials such as plastics or elastomers that are mounted on the mount body 102. In another embodiment, the mount body 102 may have no support surfaces 112 formed thereon, and the optical component 140 may be supported by the wall of the optical component receiving recess 106.

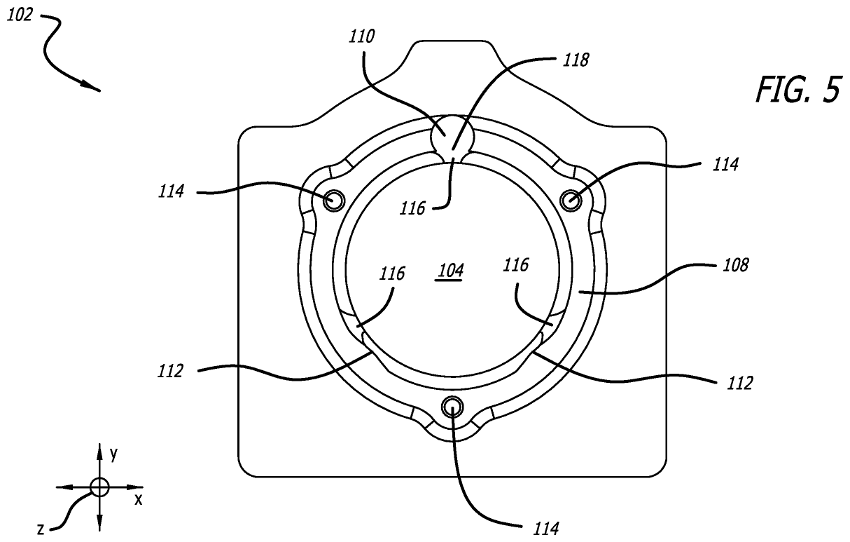

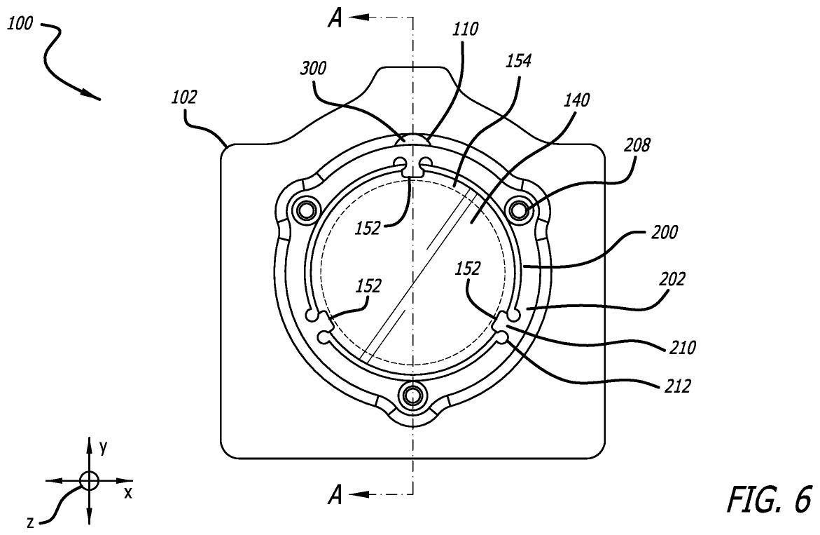

In the illustrated embodiment, as shown in FIGS. 3, 4 and 7, the optical component 140 is a circular mirror including at least one body 142, at least one edge 146, at least one first surface 144 with at least one first periphery 154, and at least one second surface 148 with at least one second periphery 158. Optionally, the optical component 140 may be a lens, waveplate, polarizes, grating, filter or the like or any combination thereof. Also, the shape of the optical component 140 may be rectangular, square, or any variety of shapes. Those skilled in the art will appreciate that the optical mount 100 may be configured to accept and retain any variety of optical components. The optical mount 100 may further include at least one elastomeric retention member 300 (also referred to herein as the “retention member 300) located within at least one retention member recess 110 formed in the mount body 102 (see FIGS. 5 and 6). In the illustrated embodiment, the elastomeric retention member 300 is configured to engage the edge 146 of the optical component 140 with a complaint retention force that is proportional to its durometer and the amount of deflection of the retention member 300 to urge the edge 146 against the support surfaces 112, thereby securely retaining the optical component 140 in the X- and Y-directions. Optionally, the elastomeric retention member 300 may be configured to engage the first periphery 154, second periphery 158 of the optical component 140, or both.

As shown in FIGS. 3-5, one or more raised regions 116 may be formed on the mount body 102, the raised regions 116 being configured to contact the second periphery 158 of the second surface 148 of the optical component 140 and retain the optical component 140 within the optical component receiving recess 106 in the Z-direction. In the illustrated embodiment, the mount body 102 includes three raised regions 116, although those skilled in the art will appreciate that any number of raised regions may be formed on the mount body 102. As shown in FIG. 5, one or more recess opening 118 may be formed in the mount body 102 between the retention member recess 110 and the optical component receiving recess 106, the recess openings being configured to allow contact between the retention member 300 and the optical component 140 along the edge 146, the first periphery 154, the second periphery 158, or any combination thereof.

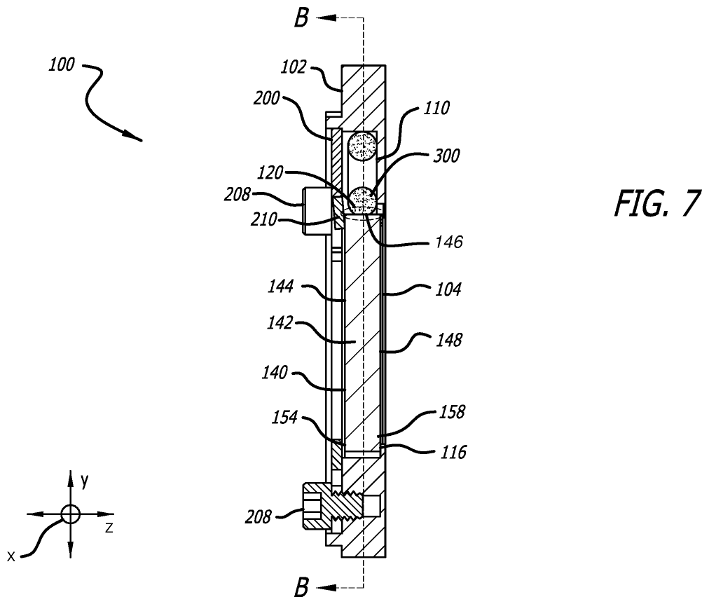

As shown in FIGS. 3, 6 and 7, the mount 100 may include at least one retention device 200 configured to contact the first periphery 154 of the first surface 144 of the optical component 140 at contact points 152, thereby securely retaining the optical component 140 within the optical component receiving recess 106 in the Z-direction. The retention device 200 may also be configured to securely retain the retention member 300 within the retention member recess 110. As shown in FIG. 3, the retention device 200 may include a body 202 with at least one aperture 204 formed therein. One or more flexure members 210 may extend from the body 202 into the aperture 204. One or more reliefs 212 may be formed in the body 202 on either side of the flexure members 210, the reliefs 212 configured to reduce localized stress in the body 202 and flexure members 210 at the point where the flexure member 210 meets the body 202. The reliefs 212 may also be operative to reduce the stiffness of the flexure member 210 at the contact points 152 on the first periphery 154 of the optical component 140. In the illustrated embodiment, three flexure members 210 are formed on the body 202, though those skilled in the art will appreciate that any number of flexure members 210 may be formed on the body 202. One or more fastener passages 206 may be formed in the body 202, the fastener passages 206 configured to accept one or more fasteners 208 to traverse therethrough and engage one or more fastener passages 114 formed in the mount body 102 so that the retention device 200 may be securely retained against the surface 108 formed in the mount body 102. In the illustrated embodiment, the flexure members 210 are configured to be opposite of the raised regions 116 in the Z-direction so that the biasing force retaining the optical component 140 in the Z-direction does not created bending stress in or deflection of the optical component 140. As shown in FIG. 7, in the illustrated embodiment, the flexure member 210 is configured to be oriented slightly out of the plane of the body 200 so that the flexure members 210 contact the first periphery 154 of the optical component 140. Optionally, the flexure members 210 may lie within the same plane as the body 202. In the illustrated embodiment, the retention device 200 is formed from stainless steel. Those skilled in the art will appreciate that the retention device 200 may be formed from any variety of materials.

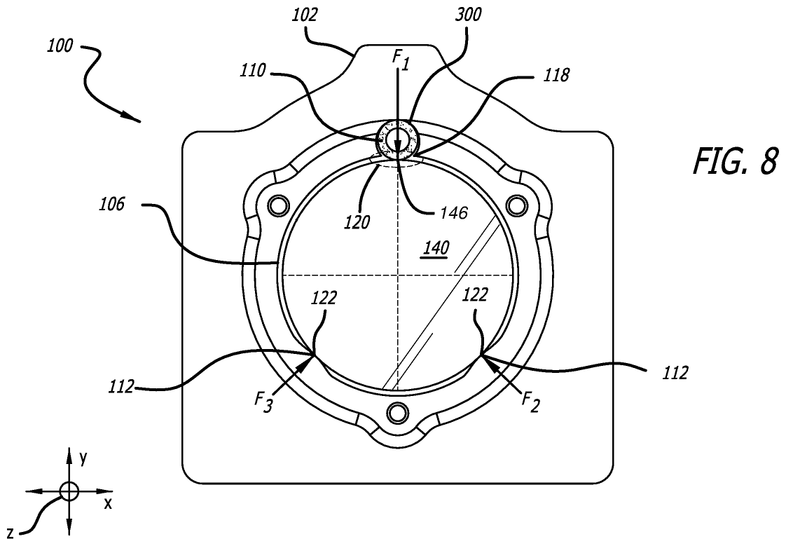

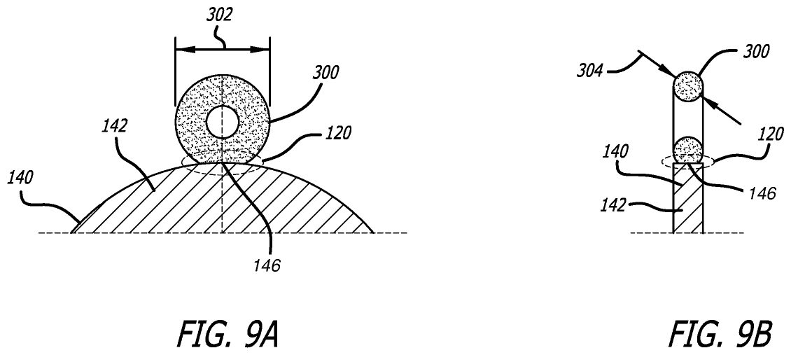

FIGS. 7-9 show various views of the optical component mount 100. As shown, the retention member 300 engages the edge 146 of the optical component 140. When the retention member 300 engages the edge 146, it deforms, resulting in a compliant retention force exerted over the contact area 120 where the retention member 300 is in contact with the optical component 140. As shown in FIGS. 9A and 9B, in the illustrated embodiment, the retention member 300 has an annular shape with an outer diameter 302 and a circular cross-section 304 (also known in the art as an “O-ring”). In the illustrated embodiment, the cross-section 304 of the retention member 300 is about the same as the thickness of the optical component 140. Those skilled in the art will appreciate that the cross section 304 of the retention member 300 may be either smaller than or larger than the thickness of the optical component 140. Exemplary elastomeric materials include, without limitation, butyl, nitrile (Buna-N), silicone, fluorocarbon, fluorosilicone, fluoroelastomer, perfluoroelastomer (FFKM), polytetrafluoroethylene (PTFE), tetrafluoroethylene propylene (TFE/P), fluorosilicone, urethane, polyurethane, ethylene-propylene (EPDM), neoprene, chloroprene, and the like. Those skilled in the art will appreciate that the retention member 300 may be made from any variety of materials. The retention member 300 material may also be selected to be compatible with cleanroom or vacuum environments. The retention member 300 material may also be selected based on its durometer, a measure of the resistance to deflection of polymers, elastomers and rubbers. For example, in the illustrated embodiment, as shown in FIG. 8, the retention member 300 exerts a compliant retention force F₁ on the optical component 140 that is proportional to its durometer and the amount of deflection of the retention member 300. Because the durometer of the retention member 300 may change with temperature, material of the retention member may be selected so that the retention force F₁ is maintained at an acceptable level to retain the optical component 140 securely, while avoiding distortion of the optical component 140. For example, high-temperature applications may require that the retention member 300 be made from a material with a higher durometer, and low-temperature applications may require that the retention member 300 be made from a material with a lower durometer. In one embodiment, the retention member 300 may be made of a material whose durometer changes little with temperature. In another embodiment, the retention member 300 may be made of a material whose durometer changes significantly with temperature. The stress created in the optical component 140 is the retention force F₁ exerted by the retention member 300 divided by the contact area 120. The details of the design of the optical component mount 100 would be selected to minimize the stress on the optical component 140 while providing a sufficient compliant retention force to prevent the optical component 140 from shifting within the optical component receiving recess 106 during use.

FIG. 8 shows a view of the mount body 102 showing the contact area 120 where the edge 146 of the optical component 140 engages the retention member 300, and the contact points 122 where the edge 146 contacts the support surfaces 112. As shown, the optical component 140 is placed in the optical component receiving recess 106 and the retention member 300 is placed in the retention member recess 110. A portion of the retention member 300 protrudes through the recess opening 118 and engages the edge 146 of the optical component 140 at the contact area 120 with a retention force F₁. As described above, in the illustrated embodiment, the retention force F₁ may be proportional to the diameter 302 of the retention member 300, the cross-section 304 of the retention member 300, the durometer of the retention member 300, the deflection or compression of the retention member 300, and the ambient temperature. Those skilled in the art will appreciate that any variety of factors may affect the magnitude of the retention force F₁. Opposing or reaction forces F₂ and F₃ are exerted at the two contact points 122 on the support surfaces 112, thereby securely retaining the optical component 140 in the X- and Y-directions within the optical component receiving recess 106. Those skilled in the art will appreciate that the optical component 140 may be supported at any number of contact points 122.

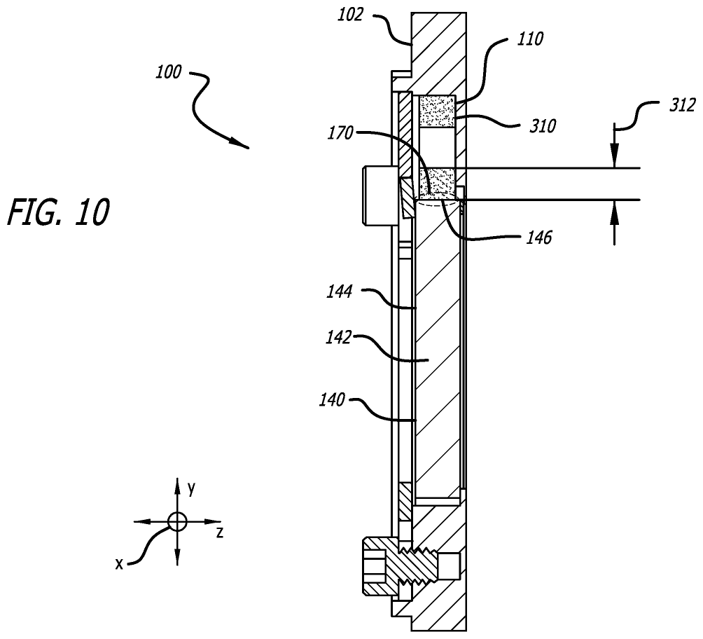

FIGS. 10-13 show cross-sectional views of various alternate embodiments of the optical component mount 100, each alternate embodiment having a different configuration of the retention member. FIG. 10 shows an embodiment of the optical component mount 100 having a retention member 310 positioned in the retention member recess 110 of the mount body 102. In the illustrated embodiment, in similar fashion to the retention member 300, the retention member 310 may be formed from an elastomeric material. Exemplary materials for the retention member 310 are similar to those listed above with respect to the retention member 300. In the illustrated embodiment, the retention member 310 has an annular shape with a square cross-section 312 and is configured to exert a compliant retention force at a contact area 170 where the retention member 310 meets the edge 146 of the optical component 140. Because the cross-section 312 of the retention member 310 is square, the contact area 170 may be larger than the contact area 120 shown in FIGS. 9A and 9B. As such, the resulting stress created within the body 142 of the optical component 140 may be lower than where the retention member 300 contacts the optical component 140. Likewise, warping of the surface 144 of the optical component 140 may minimized. Optionally, the cross-section 312 of the retention member 310 may be rectangular. Those skilled in the art will appreciate that the retention member 310 may have any variety of cross-sections.

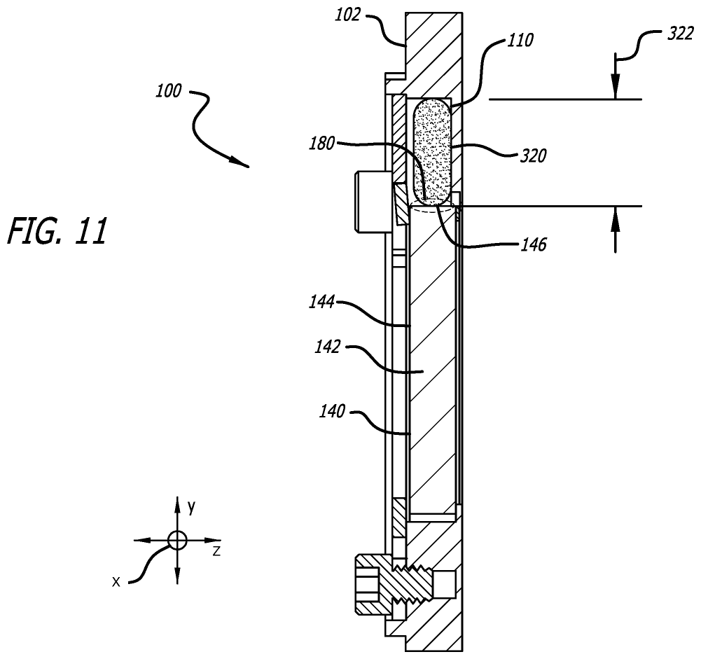

FIG. 11 shows an embodiment of the optical component mount 100 having a retention member 320 positioned in the retention member recess 110 of the mount body 102. In the illustrated embodiment, in similar fashion to the retention member 300, the retention member 320 may be formed from an elastomeric material. Exemplary materials for the retention member 320 are similar to those listed above with respect to the retention member 300. In the illustrated embodiment, the retention member 320 has a solid, oval cross-section with a diameter 322 and is configured to exert a compliant retention force at a contact area 180 where the retention member 320 engages the edge 146 of the optical component 140. Those skilled in the art will appreciate that the retention member 320 may have any variety of cross-sections. Due to the solid cross section of the retention member 320, the retention member 320 may exert a higher compliant retention force on the optical component 140, resulting in higher stresses within the body 142 and at the surface 144 of the optical component 140 relative to those exerted on the optical component by the retention member 300 or 310.

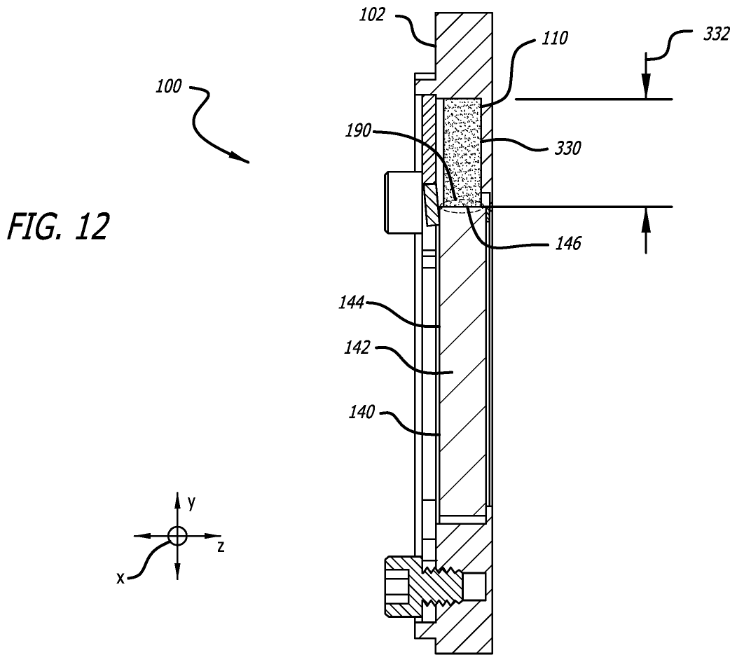

FIG. 12 shows an embodiment of the optical component mount 100 having a retention member 330 positioned in the retention member recess 110 of the mount body 102. In the illustrated embodiment, in similar fashion to the retention member 300, 310 and 320, the retention member 330 may be formed from an elastomeric material. Exemplary materials for the retention member 330 are similar to those listed above with respect to the retention member 300. In the illustrated embodiment, the retention member 330 has a solid, rectangular cross-section with a diameter 332 and is configured to exert a compliant retention force at a contact area 180 where the retention member 330 engages the edge 146 of the optical component 140. Those skilled in the art will appreciate that the retention member 330 may have any variety of cross-sections. Though the solid cross section of the retention member 330 may exert a higher compliant retention force on the optical component 140 relative to the compliant retention forces exerted by the retention members 300, 310 and 320, the contact area 180 may be larger than the respective contact areas 120, 170, and 180 described above, the stresses within the body 142 and at the surface 144 of the optical component 140 may be acceptable for some applications where the optical mount 100 is used.

The design of the optical mount 100 as described above allows for significant design flexibility so that the end user of the optical mount 100 may choose from a number of design parameters so that the optical mount 100 is ideally suited for the user's experiment, system or application. For example, to hold very thin optics that are sensitive to stress-induced birefringence, the user may specify the configuration of the retention member 300 made from a material with a low durometer, such as fluorosilicone. As another example, for a high-temperature application using relatively thicker optics, the user may specify the configuration of the retention member 310, made from a high durometer, such as fluorocarbon, so that the compliant retention force on the optical component 140 does not become too low at high temperatures. In this example, the contact area 170 at the edge of the optical component 140 retention member may be high enough so that any stresses in the optical component 140 are acceptable for the end-use application. Those skilled in the art will appreciate that that the end user may select, specify or adjust the design parameters when choosing any particular configuration of the optical component 100.

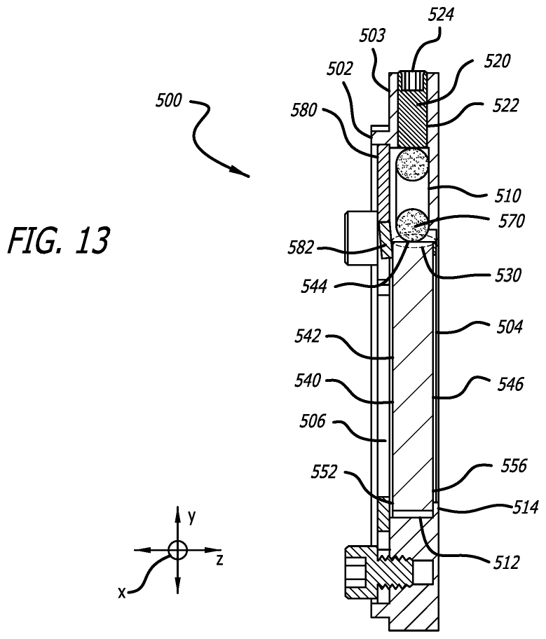

FIG. 13 shows a section view of an embodiment of an optical component mount 500 (also referred to herein as the “optical mount 500”). In many respects, the optical mount 500 is similar to the optical mount 100 described above. The optical mount 500 may include at least one body 502 having at least one aperture 504 and at least one optical component receiving recess 506 formed therein, the optical component receiving recess 506 configured to accept at least one optical component 540 therein. At least one retention member recess 510 configured to receive at least one retention member 570 therein may be formed in the mount body 502. The mount body 502 may include at least one extended region 503 formed thereon. At least one adjustment member passage 522 may be formed in the extended region 503 of the mount body 502, with the adjustment member passage 522 configured to accept at least one adjustment member 520 configured to exert an adjustable biasing force operative to deflect the retention member 570, so that the retention member 570 exerts an adjustable compliant retention force over at least one contact area 530 on the edge 544 of the optical component 540, thereby securely retaining it within the optical component receiving recess 506. In the illustrated embodiment, the adjustment member 520 is a set screw, similar to the set screw 14 described above with respect to the optical component mount 10. The adjustment member 520 may be actuated by placing a tool such as an Allen wrench into an adjustment port 524 formed in the adjustment member 520. Those skilled in the art will appreciate that the retention member 570 may also have the same or similar alternative cross-sections described above with respect to retention members 300, 310, 320 and 330. Likewise, the retention member 570 may be made of any of the elastomeric materials listed above with respect to the retention member 300. The optical component mount 500 may include at least one retention device 580 configured to retain the optical component 540 within the optical component receiving recess 506 and to retain the retention member 570 within the retention member recess 510 in the Z-direction. The retention device 580 may include at least one flexure member 582 formed thereon, the flexure member 582 being configured to engage at least one first periphery 552 of at least one first surface 542 of the optical component 540 and exert a biasing force to urge at least one second periphery 556 of at least one second surface 546 against one or more raised regions 514 formed on the mount body 502 to securely retain the optical component 540 in the optical component receiving recess 506 in the Z-direction. The optical component mount 500 further includes one or more fasteners 588 configured to engage one or more fastener passages 514 to securely retain the retention device 580 against the mount body 502.

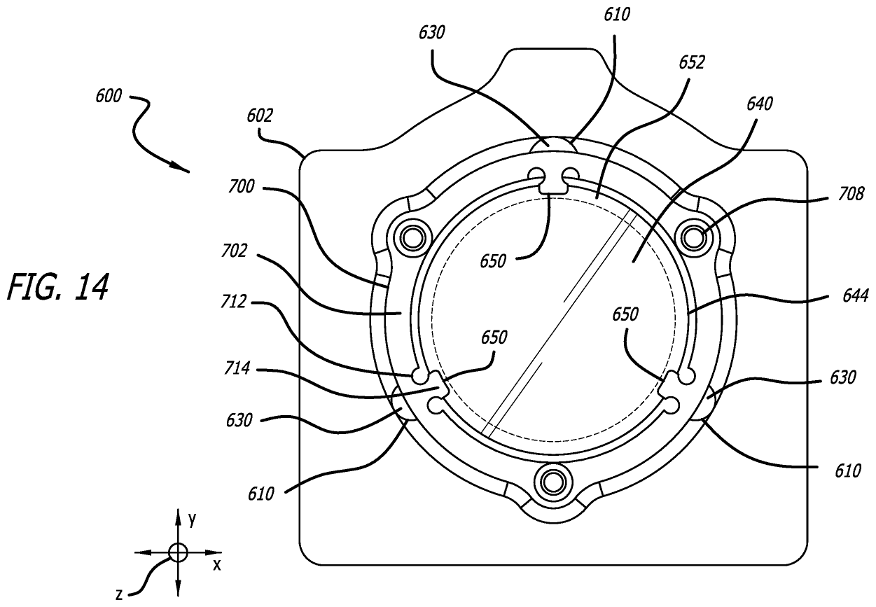

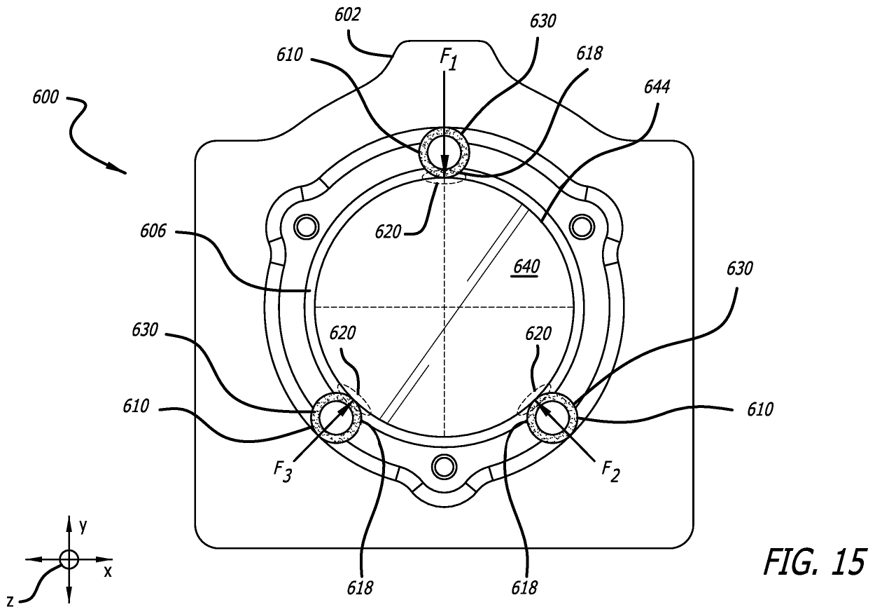

FIGS. 14 and 15 show views of an embodiment of an optical component mount 600. As shown, the optical component mount 600 (also referred to herein as the optical mount 600″) may include at least one mount body 602, with at least one optical component receiving recess 606 formed therein, the optical component receiving recess 606 configured to receive at least one optical component 640 therein. The optical mount 600 may further include at least one retention device 700 with a body 702 that may include one or more flexure members 714 configured to contact a periphery 652 of the optical component 640 at one or more contact points 650, thereby securely retaining the optical component 640 within the optical component receiving recess 606 in the Z-direction. One or more reliefs 712 may be formed in the body 702 adjacent to the flexure members 714, the reliefs 712 configured to reduce or otherwise control the force exerted by the flexure members 714 on the periphery 652 of the optical component 640. The mount body 602 may further include one or more retention member recesses 610 configured to accept one or more retention members 630, the retention members 630 being configured to contact at least one edge 644 of the optical component 640 over a contact area 620. In the illustrated embodiment, the optical mount 600 includes three retention members 630, though those skilled in the art will appreciate that the optical mount 600 may use any number of retention members 630. In similar fashion to the retention member 300, the retention members 630 may be formed from an elastomeric material. Exemplary materials for the retention member 630 are similar to those listed above with respect to the retention member 300. As shown in FIG. 15, one or more recess openings 618 configured to allow the retention members 630 to protrude therethrough to contact the optical component 640 may be formed in the mount body 602 at the interface between the retention member recesses 610 and the optical component receiving recess 606. The retention device 700 may be detachably mounted to the mount body 602 by one or more fasteners 708. The retention device 700 may be further configured to retain the retention devices 630 within the respective retention member recesses 610.

FIG. 15 shows a view of the optical mount 600 showing compliant retention forces F₁, F₂ and F₃ exerted by the retention members 630 to securely retain the optical component 640 within the optical component receiving recess 606 in the X- and Y-directions. For the purpose of illustration, the retention device 700 is not shown in FIG. 15. As shown, the forces F₁₋₃ contact the optical component 640 at contact areas 620. In the illustrated embodiment, the retention members 630 are similar in configuration to the retention member 300 described above with respect to the optical mount 100. In contrast to the optical mount 100 described above, because multiple retention members 630 are used, each having an annular configuration, the localized stresses in the optical component 640 caused by forces F₂ and F₃ may be lower than the corresponding localized stresses created in the optical component 140 caused by contact between the optical component 140 and the support surfaces 112 at the contact points 122 as shown in FIG. 8. Those skilled in the art will appreciate that the retention members 630 may also have the same or similar alternative cross-sections described above with respect to retention members 310, 320, 330, and 570.

While an optical component mount is disclosed by reference to the various embodiments and examples described above, it should be understood that these examples are intended in an illustrative rather than limiting sense, as it is contemplated that modifications will readily occur to those skilled in the art which are intended to fall within the scope of the present invention.

What is claimed is:

1. An optical component mount, comprising:
at least one mount body with at least one optical component receiving recess formed therein, the at least one optical component receiving recess configured to receive at least one optical component therein, the at least one optical component having at least one edge; and
at least one elastomeric retention member configured to exert at least one compliant retention force on the at least one edge of the at least one optical component and securely retain the at least one optical component within the at least one optical component receiving recess in at least one first direction.

2. The optical component mount of claim 1, wherein the at least one elastomeric retention member has an annular shape with a substantially circular cross-section.

3. The optical component mount of claim 1, wherein the at least one elastomeric retention member has an annular shape with a rectangular cross-section.

4. The optical component mount of claim 1, wherein the at least one elastomeric retention member has an oval cross-section.

5. The optical component mount of claim 1, wherein the at least one elastomeric retention member has a rectangular cross-section.

6. The optical component mount of claim 1, wherein the at least one elastomeric retention member is formed from a material selected from a group consisting of butyl, nitrile (Buna-N), silicone, fluorocarbon, fluorosilicone, fluoroelastomer, urethane, polyurethane, perfluoroelastomer (FFKM), polytetrafluoroethylene (PTFE), tetrafluoroethylene propylene (TFE/P), ethylene-propylene (EPDM), neoprene, and chloroprene.

7. The optical component mount of claim 1, further comprising at least one adjustment member configured to exert at least one adjustable force on the at least one elastomeric retention member, thereby adjusting the compliant retention force applied to the at least one edge of the at least one optical component by the elastomeric retention member.

8. The optical component mount of claim 1, further comprising at least one retention device configured to contact the at least one optical component on at least one first periphery and securely retain the at least one optical component in at least one second direction.

9. An optical component mount, comprising:
at least one mount body with at least one optical component receiving recess formed therein, the at least one optical component receiving recess configured to receive at least one optical component therein, the at least one optical component having at least one contact area and at least one first periphery;
at least one first elastomeric retention member configured to contact the at least one optical component at at least one contact area and securely retain the at least one optical component in at least one first direction; and
at least one second elastomeric retention member configured to contact the at least one optical component at at least one contact area and securely retain the at least one optical component in at least one second direction.

10. The optical component mount of claim 9, further comprising at least one third elastomeric retention member configured to contact the at least one optical component at at least one contact area and securely retain the at least one optical component in at least one third direction.

11. The optical component mount of claim 9, wherein the at least one elastomeric retention member has a substantially circular cross-section.

12. The optical component mount of claim 9, wherein the at least one elastomeric retention member has an annular shape with a rectangular cross-section.

13. The optical component mount of claim 9, wherein the at least one elastomeric retention member has an oval cross-section.

14. The optical component mount of claim 9, wherein the at least one elastomeric retention member has a rectangular cross-section.

15. The optical component mount of claim 9, wherein the at least one elastomeric retention member for from a material selected from a group consisting of butyl, nitrile (Buna-N), silicone, fluorocarbon, fluorosilicone, fluoroelastomer, urethane, polyurethane, perfluoroelastomer (FFKM), polytetrafluoroethylene (PTFE), tetrafluoroethylene propylene (TFE/P), ethylene-propylene (EPDM), neoprene, and chloroprene.
